(19) United States
(12) Patent Application Publication
(10) Pub. No.: US 2025/0390551 A1
(43) Pub. Date: Dec. 25, 2025

(54) CALCULATION DEVICE AND CALCULATION METHOD

(71) Applicant: REALTEK SEMICONDUCTOR CORP., Hsinchu (TW)

(72) Inventors: Chon-Hou Sio, Hsinchu (TW); Chia-Wei Yu, Hsinchu (TW)

(73) Assignee: REALTEK SEMICONDUCTOR CORP., Hsinchu (TW)

(21) Appl. No.: 18/974,101

(22) Filed: Dec. 9, 2024

(30) Foreign Application Priority Data
Jun. 25, 2024 (TW) 113123659

(51) Int. Cl. G06F 17/16

(52) U.S. Cl. CPC G06F 17/16

(57) ABSTRACT

A calculation device and a calculation method are provided. The calculation method includes: selecting, by a selection unit, at least one first element from a one-axis tensor which satisfies a selection condition; selecting and loading, by a control unit, at least one second element from a two-axis tensor based on an operation between the two-axis tensor and the one-axis tensor and at least one position of the at least one first element in the one-axis tensor; and obtaining and outputting, by a calculation unit, an operation result corresponding to the operation between the two-axis tensor and the one-axis tensor based on the at least one first element and the at least one second element.

### CROSS-REFERENCE TO RELATED APPLICATION

This non-provisional application claims priority under 35 U.S.C. § 119(a) to patent application No. 113123659 filed in Taiwan, R.O.C. on Jun. 25, 2024, the entire contents of which are hereby incorporated by reference.

### BACKGROUND

### Technical Field

The present invention relates to the field of calculation devices and calculation methods, and in particular, to a calculation device and a calculation method applied to an operation between a vector and a matrix.

### Related Art

During processing of a large language model (LLM) or a transformer-based model, a bottleneck of an inference speed changes from a compute bound to a memory bandwidth bound as a quantity of model parameters increases. Since a quantity of current large model parameters is generally more than 7 billion, a greater burden on a system is an amount of reading and writing of a model matrix element compared with an increase in a quantity of operations. When the amount of reading and writing of the model matrix element exceeds a memory bandwidth of the system, it means that operation resources cannot be fully utilized, causing the inference speed to become the memory bandwidth bound. The foregoing problems are further magnified when the LLM or the transformer-based model is deployed on an edge device, because SRAMs or DRAMs of edge devices generally have a small capacity and the memory bandwidth is also limited.

### SUMMARY

In view of this, some embodiments of the present invention provide a calculation device and a calculation method, to alleviate the problems of the prior art.

Some embodiments of the present invention provide a calculation device, including a selection unit, a control unit, and a calculation unit. The selection unit is configured to select at least one first element from a one-axis tensor which satisfies a selection condition. The control unit is configured to perform a step of: (a) selecting and loading at least one second element from a two-axis tensor based on an operation between the two-axis tensor and the one-axis tensor and at least one position of the at least one first element in the one-axis tensor; and (b) obtaining and outputting an operation result corresponding to the operation between the two-axis tensor and the one-axis tensor based on the at least one first element and the at least one second element.

Some embodiments of the present invention provide a calculation method, including: selecting, by a selection unit, at least one first element from a one-axis tensor which satisfies a selection condition; selecting and loading, by a control unit, at least one second element from a two-axis tensor based on an operation between the two-axis tensor and the one-axis tensor and at least one position of the at least one first element in the one-axis tensor; and obtaining and outputting, by a calculation unit, an operation result corresponding to the operation between the two-axis tensor and the one-axis tensor based on the at least one first element and the at least one second element.

Based on the above, according to the calculation device and the calculation method provided in some embodiments of the present invention, an amount of data that needs to be loaded from the external memory is reduced, so that a quantity of inputs and outputs of the memory may be reduced, and the memory bandwidth required to read the two-axis tensor may also be reduced.

### BRIEF DESCRIPTION OF THE DRAWINGS

FIG. 1 is a block diagram of a calculation device according to some embodiments of the present invention.

FIG. 2 and FIG. 3 are schematic diagrams of matrix multiplication according to some embodiments of the present invention.

FIG. 4 is a schematic diagram of a one-axis tensor according to some embodiments of the present invention.

FIG. 5 is a schematic diagram of a two-axis tensor according to some embodiments of the present invention.

FIG. 6 is a schematic flowchart of a calculation method according to some embodiments of the present invention.

FIG. 7 is a schematic diagram of an architecture of a calculation unit according to some embodiments of the present invention.

FIG. 8 is a block diagram of a calculation device according to some embodiments of the present invention.

FIG. 9 is a schematic flowchart of a calculation method according to some embodiments of the present invention.

FIG. 10 is a schematic system block diagram of an electronic device according to some embodiments of the present invention.

FIG. 11 is a flowchart of a calculation method according to some embodiments of the present invention.

FIG. 12 is a flowchart of a calculation method according to some embodiments of the present invention.

FIG. 13 is a flowchart of a calculation method according to some embodiments of the present invention.

FIG. 14 is a flowchart of an element multiplication and accumulation process according to some embodiments of the present invention.

FIG. 15 is a flowchart of a calculation method according to some embodiments of the present invention.

FIG. 16 is a flowchart of a calculation method according to some embodiments of the present invention.

FIG. 17 is a flowchart of a calculation method according to some embodiments of the present invention.

### DETAILED DESCRIPTION

The foregoing and other technical contents, features, and effects of the present invention are to be clearly presented in the following detailed description of embodiments with reference to the drawings. Any modification and change that does not affect the efficacy and the purpose of the present invention shall still fall within the scope covered by the technical content disclosed in the present invention. The same reference numerals are used to indicate the same or similar elements in all of the drawings. A term “connection” mentioned in the following embodiments may refer to any direct or indirect and wired or wireless connection means. Terms with similar to ordinal numbers such as “first” or “second” described herein are used to distinguish or refer to associated same or similar elements or structures, and do not necessarily imply an order of such elements in a system. It is to be understood that in some cases or configurations, the ordinal numbers may be used interchangeably without affecting implementation of the present invention.

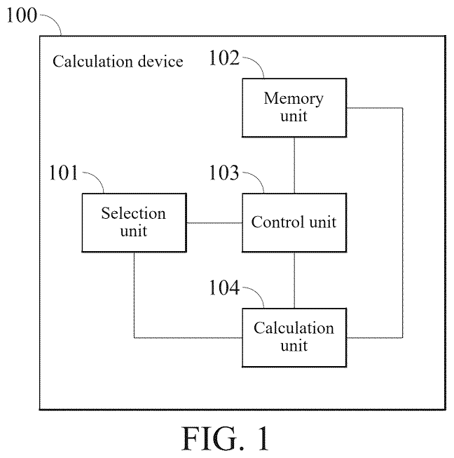

FIG. 1 is a block diagram of a calculation device according to some embodiments of the present invention. Referring to FIG. 1, a calculation device 100 includes a selection unit 101, a memory unit 102, a control unit 103, and a calculation unit 104. The selection unit 101 is configured to select at least one element (referred to as at least one first element below for ease of description) from a one-axis tensor which satisfies a selection condition. The control unit 103 is configured to access a two-axis tensor from an external memory. The memory unit 102 is configured to store a result of the foregoing two-axis tensor accessed by the control unit 103. The calculation unit 104 is configured to obtain an operation result of an operation between the foregoing two-axis tensor and the foregoing one-axis tensor based on the result accessed by the control unit 103 and at least one first element selected from the foregoing one-axis tensor that satisfies the selection condition. The calculation unit 104 is configured to output the foregoing operation result.

The calculation method and cooperation between modules of the calculation device 100 according to some embodiments of the present invention are described in detail below with reference to the drawings.

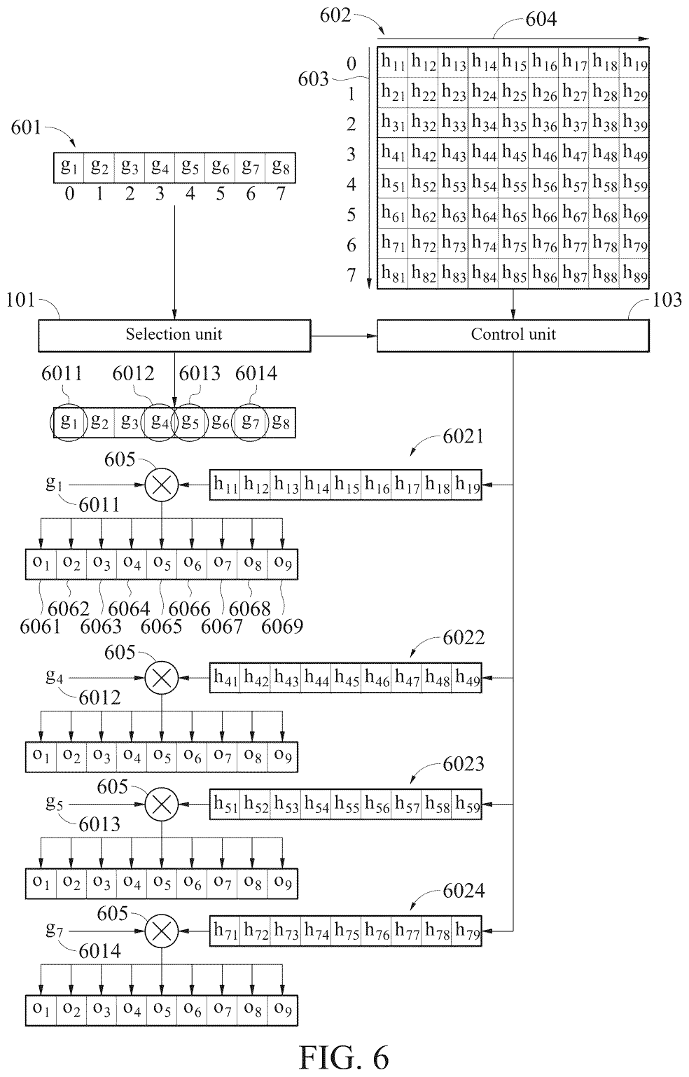

FIG. 6 is a schematic flowchart of a calculation method according to some embodiments of the present invention. FIG. 11 is a flowchart of a calculation method according to some embodiments of the present invention. Referring to FIG. 1, FIG. 6, and FIG. 11 together, in an embodiment shown in FIG. 11, the calculation method includes step S1101 to step S1103. In step S1101, a selection unit 101 selects at least one first element from a one-axis tensor which satisfies a selection condition. An embodiment shown in FIG. 6 is used as an example. The selection unit 101 selects elements including g₁ (an element 6011), g₄ (an element 6012), g₅ (an element 6013), and g₇ (an element 6014) (g₁, g₄, g₅, and g₇ are referred to as first elements herein) from a one-axis tensor 601 which satisfy the selection condition. In step S1102, the control unit 103 selects and loads at least one second element from a two-axis tensor based on an operation between the two-axis tensor (for example, a two-axis tensor 602 shown in FIG. 6) and the foregoing one-axis tensor (for example, the one-axis tensor 601 shown in FIG. 6) and at least one position of the foregoing at least one first element in the one-axis tensor. In step S1103, the calculation unit 104 obtains and outputs an operation result corresponding to an operation between the two-axis tensor and the one-axis tensor based on the at least one first element and the at least one second element.

In the above embodiments, since an amount of data that needs to be loaded from the external memory is reduced, a quantity of inputs and outputs of the memory may be reduced, and the memory bandwidth required to read the two-axis tensor may also be reduced.

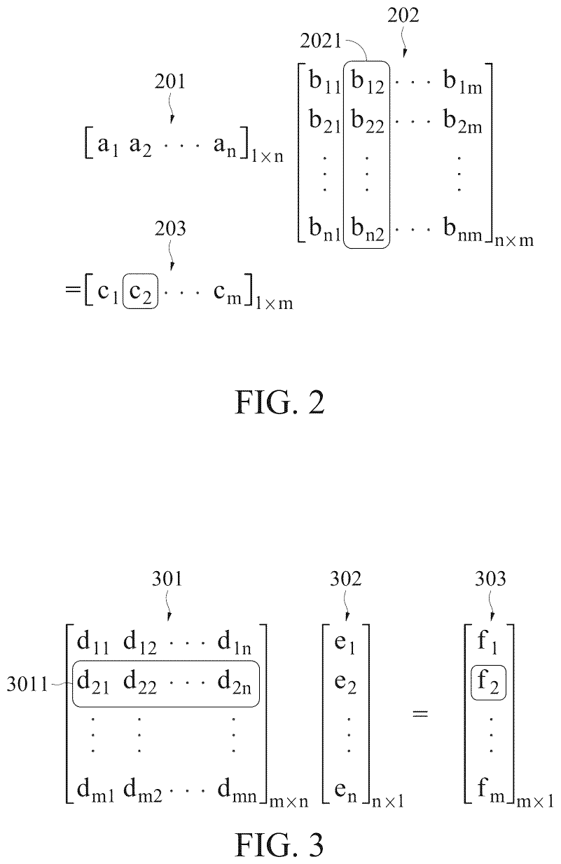

In some embodiments of the present invention, the foregoing operation is a matrix multiplication operation. FIG. 2 and FIG. 3 are schematic diagrams of matrix multiplication according to some embodiments of the present invention. Referring to FIG. 2 and FIG. 3 first, FIG. 2 shows a vector 201 multiplied by a matrix 202 to obtain a vector 203, where a₁, a₂, . . . , and aₙ are elements of the vector 201. For 1≤i≤n and 1≤j≤m, b_{i,j} is an element of the matrix 202. According to a definition of the matrix multiplication, for 1≤k≤ m,

$${c}_{k} = {\sum }_{l = 1}^{n} {a}_{l} {b}_{l k} .$$

In other words, for the multiplication of the vector 201 by the matrix 202, a value of an element cₖ of the vector 203 may be calculated by multiplying an element of the vector 201 by elements at corresponding positions in a k^{th} column of the matrix 202 individually and summing the products (for example, as shown in FIG. 2, an element c₂ of the vector 203 is obtained by multiplying an element of the vector 201 by elements at corresponding positions in a 2^{nd} column (column 2021) of the matrix 202 individually and summing the products).

FIG. 3 shows a matrix 301 multiplied by a vector 302 to obtain a vector 303, where e₁, e, . . . , and eₙ are elements of the vector 302. For 1≤i≤m and 1≤j≤n, d_{i,j} is an element of the matrix 301. According to the definition of the matrix multiplication, for 1≤k≤ m,

$${f}_{k} = {\sum }_{l = 1}^{n} {d}_{k l} {e}_{l} .$$

In other words, for the multiplication of the matrix 301 by the vector 302, a value of an element fₖ of the vector 303 may be calculated by multiplying elements in a k^{th} row of the matrix 301 individually by elements of the vector 302 at corresponding positions and summing the products (for example, as shown in FIG. 3, an element f₂ of the vector 303 is obtained by multiplying elements in a 2^{nd} row (row 3011) of the matrix 301 individually by elements of the vector 302 at corresponding positions and summing the products).

In a practical application, due to different data arrangements, both of the multiplications between a matrix and a vector as shown in FIG. 2 and FIG. 3 may be used. To perform the two multiplications between the matrix and the vector shown in FIG. 2 and FIG. 3 in a computer, the vector 201 or the vector 302 may be stored in a one-axis tensor, and the matrix 202 or the matrix 301 may be stored in a two-axis tensor.

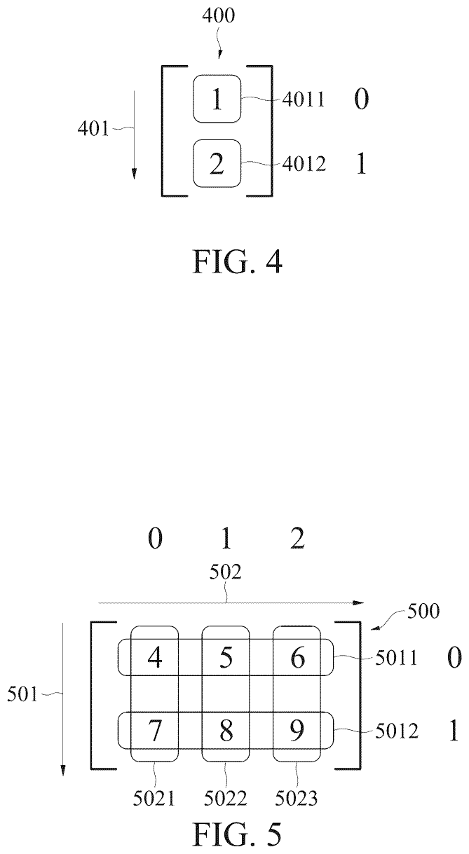

FIG. 4 is a schematic diagram of a one-axis tensor according to some embodiments of the present invention. FIG. 5 is a schematic diagram of a two-axis tensor according to some embodiments of the present invention. Each part of the one-axis tensor and the two-axis tensor is described below by using FIG. 4 and FIG. 5. Referring to FIG. 4, a one-axis tensor 400 includes a 0^{th} axis 401. The one-axis tensor 400 has an element 4011 and an element 4012 on the 0^{th} axis 401. The one-axis tensor 400 may index an element on the 0^{th} axis 401 by using an index value. For example, an element of the one-axis tensor 400 having an index value of 0 on the 0^{th} axis 401 is 4011, and an element of the one-axis tensor 400 having an index value of 1 on the 0th axis 401 is 4012.

Referring to FIG. 5, a two-axis tensor 500 includes a 0^{th} axis 501 and a 1^{st} axis 502. The two-axis tensor 500 has 2 elements such as an element 5011 having an index value of 0 and an element 5012 having an index value of 1 on the 0^{th} axis 501. In this case, the two-axis tensor 500 has a dimension of 2 on the 0^{th} axis 501. The two-axis tensor 500 has an element 5021 having an index value of 0, an element 5022 having an index value of 1, and an element 5023 having an index value of 2 on the 1^{st} axis 502. In this case, the two-axis tensor 500 has a dimension of 3 on the 1^{st} axis 502. The two-axis tensor 500 is sometimes referred to as a two-dimensional matrix. The element 5011 and the element 5012 are also referred to as row vectors, and the element 5021, the element 5022, and the element 5023 are also referred to as column vectors.

When the two-axis tensor 500 is configured to perform the multiplication shown in FIG. 2 (namely, premultiplication of the two-axis tensor 500 by a vector), the 0^{th} axis 501 is referred to as an input axis, and the 1^{st} axis 502 is referred to as an output axis. In this case, a quantity of elements of the two-axis tensor 500 on the input axis is equal to a quantity of elements of the vector by which the two-axis tensor 500 is premultiplied, and a quantity of elements of the two-axis tensor 500 on the output axis is equal to a quantity of elements of the vectors of multiplication results. FIG. 2 is used as an example. If the one-axis tensor stores the vector 201 and the two-axis tensor stores the matrix 202, the quantity of elements of the two-axis tensor on the input axis is n (also referred to as a dimension of n of the two-axis tensor on the input axis), and a quantity of elements of the two-axis tensor on the output axis is m (also referred to as a dimension of m of the two-axis tensor on the output axis).

When the two-axis tensor 500 is configured to perform the multiplication shown in FIG. 3 (namely, postmultiplication of the two-axis tensor 500 by a vector), the 1^{st} axis 502 is referred to as an input axis, and the 0^{th} axis 501 is referred to as an output axis. In this case, a quantity of elements of the two-axis tensor 500 on the input axis is equal to a quantity of elements of the vector by which the two-axis tensor 500 is postmultiplied, and a quantity of elements of the two-axis tensor 500 on the output axis is equal to a quantity of elements of the vectors of multiplication results.

FIG. 12 is a flowchart of a calculation method according to some embodiments of the present invention. Referring to FIG. 6 and FIG. 12 together, in an embodiment shown in FIG. 12, the operation between the two-axis tensor and the one-axis tensor described above is the matrix multiplication operation (as shown in FIG. 2 and FIG. 3). Step S1102 described above includes selecting, by the control unit 103, to-be-loaded elements corresponding to positions of the foregoing first elements in the one-axis tensor from input axis elements (for example, the element 5011 and the element 5012) on the input axis of the two-axis tensor, and loading the elements. Each of the loaded elements corresponds to one of the positions of the first elements in the one-axis tensor, and the second element includes an element included in each loaded element.

The embodiment shown in FIG. 6 is used as an example for description. The selection unit 101 selects elements including g₁, g₄, g₅, and g₅ (g₁, g₄, g₅, and g₇ are referred to as first elements herein) from the one-axis tensor 601 which satisfy the selection condition. The elements g₁, g₄, g₅, and g₇ respectively have index values of 0, 3, 4, and 6 in the one-axis tensor 601 on the 0^{th} axis. Therefore, in step S1102, the control unit 103 selects the to-be-loaded element corresponding to the position of each of the elements g₁, g₄, g₅, and g₇ (the elements g₁, g₄, g₅, and g₇ are referred to as the first elements herein) in the two-axis tensor 602 from the input axis elements (each row of the two-axis tensor 602) on the input axis 603 of the two-axis tensor 602. The positions of the elements g₁, g₄, g₅, and g₇ (g₁, g₄, g₅, and g₇ are referred to as the first elements herein) in the one-axis tensor 601 may be represented by the index values of 0, 3, 4, and 6 on the 0^{th} axis herein. Therefore, based on the index values of 0, 3, 4, and 6 on the 0^{th} axis of the one-axis tensor 601, the selection unit 101 correspondingly selects an element 6021, an element 6022, an element 6023, and an element 6024 having the index values of 0, 3, 4, and 6 from the input axis 603 of the two-axis tensor 602 as the to-be-loaded elements and loads the elements. The foregoing second element includes elements (that is, elements h₁₁, . . . , and h₁₉ included in the element 6021, elements h₄₁, . . . , and h₄₉ included in the element 6022, elements h₅₁, . . . , and h₅₉ included in the element 6023, and elements h₇₁, . . . , and h₇₉ included in the element 6024) included in each loaded element (which are the element 6021, the element 6022, the element 6023, and the element 6024).

In some embodiments of the present invention, carrying on with the foregoing embodiment of FIG. 12, step S1201 includes successively obtaining the to-be-loaded element corresponding to the position of the first element in the one-axis tensor from an external memory through direct memory access (DMA) based on a sequence of the position of the first element in the one-axis tensor. The embodiment shown in FIG. 6 is used as an example. When the selection unit 101 correspondingly selects, based on the index values of 0, 3, 4, and 6 on the 0^{th} axis of the one-axis tensor 601, the element 6021, the element 6022, the element 6023, and the element 6024 having the index values of 0, 3, 4, and 6 from the input axis 603 of the two-axis tensor 602 as the to-be-loaded elements and loads the elements, the selection unit 101 does not directly load all of the element 6021, the element 6022, the element 6023, and the element 6024, but successively loads the element 6021, the element 6022, the element 6023, and the element 6024 in the one-axis tensor from an external memory through DMA based on a sequence (for example, based on the sequence of the index values of 0, 3, 4 and 6) of the positions of the first elements in the one-axis tensor.

It is to be noted that, in the foregoing description, the element 6021, the element 6022, the element 6023, and the element 6024 are successively loaded through the DMA based on the sequence of the index values of 0, 3, 4, and 6. However, the element 6022, the element 6021, the element 6023, and the element 6024 may also be loaded based on another sequence, for example, a sequence of index values of 3, 0, 4, and 6.

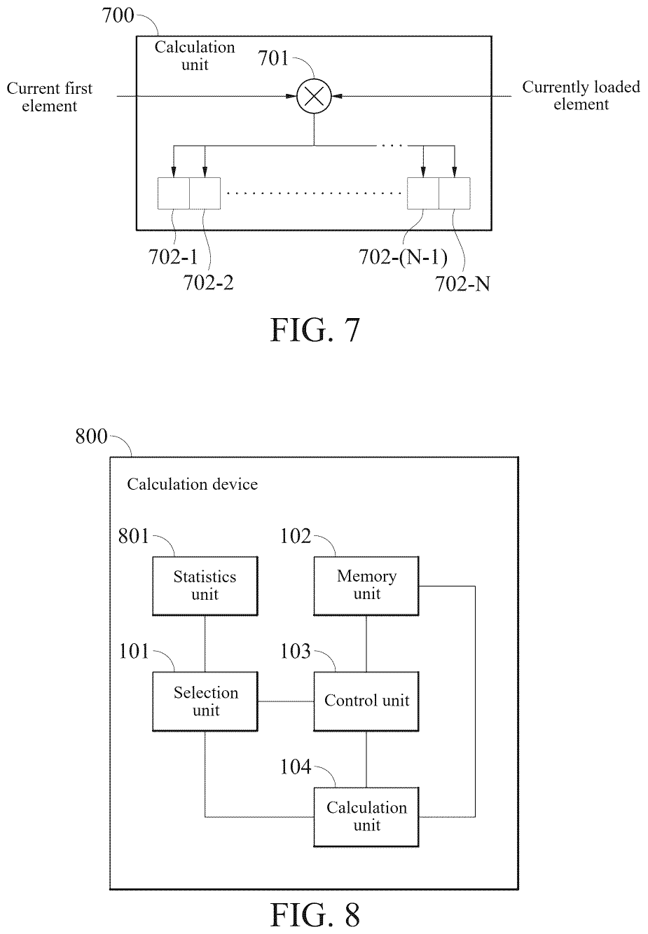

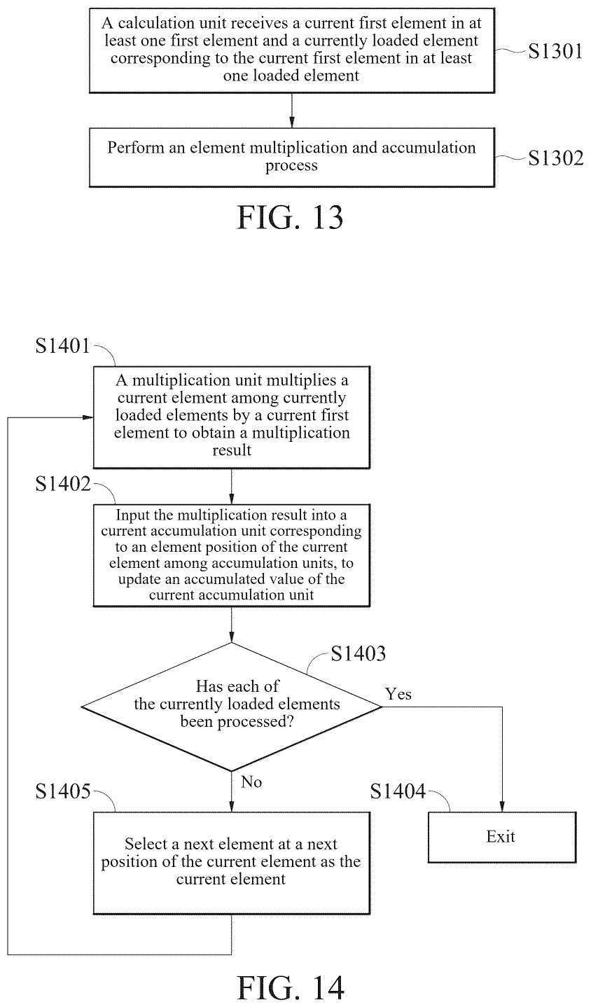

FIG. 7 is a schematic diagram of an architecture of a calculation unit according to some embodiments of the present invention. FIG. 13 is a flowchart of a calculation method according to some embodiments of the present invention. Referring to FIG. 6, FIG. 7, and FIG. 13 together, carrying on with the foregoing embodiment shown in FIG. 12, in some embodiments of the present invention, an architecture of the calculation unit 104 is the same as that of a calculation unit 700. The calculation unit 700 includes a multiplication unit 701 and accumulation units 702-1 to 702-N, where N is a positive integer, and a value of N is a dimension of the two-axis tensor on the output axis. In FIG. 6, a multiplication unit 605 is the multiplication unit 701. Corresponding to the embodiment of FIG. 6, N is 9 (the same as the dimension of the two-axis tensor 602 on the output axis 604), and accumulation units 6061-6069 are the same as the accumulation units 702-1 to 702-9. The multiplication unit 701 is configured to multiply two received numerical values and output the product. Each of the accumulation units 702-1 to 702-N is configured to add the received numerical value to a stored accumulated value. An accumulated value of each of the accumulation units 702-1 to 702-N is initially 0. In this embodiment, the foregoing step S1103 includes steps S1301-S1302.

In step S1301, the calculation unit 104 receives a current first element among the first elements to be processed, and a currently loaded element corresponding to the current first element among the to-be-loaded elements (the calculation unit 104 loads the currently loaded element from the memory unit 102). The embodiment shown in FIG. 6 is used for description. The first elements are elements g₁, g₄, g₅, and g₇. The calculation unit 104 receives the element g₁ as the current first element and the element 6021 corresponding to the element g₁ as the currently loaded element. In step S1302, the calculation unit 104 performs an element multiplication and accumulation process for the received current first element and the currently loaded element.

FIG. 14 is a flowchart of an element multiplication and accumulation process according to some embodiments of the present invention. Referring to FIG. 6, FIG. 7, FIG. 13, and FIG. 14 together, in an embodiment shown in FIG. 14, the element multiplication and accumulation process includes steps S1401-S1405. In step S1401, the multiplication unit 701 multiplies a current element among currently loaded elements by a current first element to obtain a multiplication result. The embodiment shown in FIG. 6 is used as an illustrative example. The element g₁ is the current first element, the element 6021 corresponding to the element g₁ is the currently loaded element, and the current element in the element 6021 is initially the element h₁₁. The multiplication unit 701 multiplies the element h₁₁ by the element g₁ to obtain a multiplication result h₁₁·g₁.

In step S1402, the calculation unit 104 inputs the multiplication result into a current accumulation unit corresponding to an element position of the current element in the accumulation units 702-1 to 702-N, to update an accumulated value of the current accumulation unit. Carrying on with the foregoing illustrative example, since the element position of the element calculation (which is the current element at present) is at a first position of the element 6021 (the index value is 0), the calculation unit 104 inputs the multiplication result h₁₁·g₁ into the accumulation unit 6061 (corresponding to the accumulation unit 702-1). Since the element 6021 is a currently loaded element that is loaded first, the accumulated value o₁ in the accumulation unit 6061 is currently 0. After the multiplication result h₁₁·g₁ is inputted, the accumulated value o₁ is updated to h₁₁·g₁.

In step S1403, the calculation unit 104 determines whether each of the currently loaded elements is processed. If so, step S1404 is performed, and if not, step S1405 is performed. Carrying on with the foregoing illustrative example, the calculation unit 104 determines whether each of the elements 6021 (that is, elements h₁₁, . . . , and h₁₉) is processed. In the illustrative example, only the element h₁₁ has been processed so far. Therefore, the calculation unit 104 determines that not all of the elements 6021 (that is, elements h₁₁, . . . , and h₁₉) have been processed.

In step S1404, the calculation unit 104 exits the element multiplication and accumulation process in response to a plurality of elements of the currently loaded element being all processed. When the calculation unit 104 receives a new currently loaded element corresponding to a new current first element again, the element multiplication and accumulation process is performed again based on the new current first element and the new currently loaded element. In step S1405, the calculation unit 104 selects a next element at a next position of the current element as the current element in response to the currently loaded element having not been fully processed, and performs step S1401.

Referring to FIG. 1, FIG. 6, FIG. 7, FIG. 13, and FIG. 14 together, in the embodiment shown in FIG. 6, after the calculation unit 104 performs the element multiplication and accumulation process for the element g₁ (which is the current first element at present) and the element 6021 (which is the currently loaded element at present) corresponding to the element g₁, the accumulated value o₁ is h₁₁·g₁, the accumulated value o₂ is h₁₂·g₁, . . . , and the accumulated value o₉ is h₁₉·g₁.

The calculation unit 104 continuously receives the current first element to be processed and the currently loaded element corresponding to the current first element among the to-be-loaded elements transmitted by the control unit 103, and correspondingly performs the foregoing step S1302 (including steps S1401-S1405), to obtain an operation result of the matrix multiplication operation between the one-axis tensor and the two-axis tensor. The embodiment shown in FIG. 6 is used as an example. The calculation unit 104 continuously receives the element g₄ and the element 6022 corresponding to the element g₄, the element g₅ and the element 6023 corresponding to the element g₅, and the element g₇ and the element 6024 corresponding to the element g₇ transmitted by the control unit 103, and performs the foregoing step S1302 (including steps S1401-S1405), to obtain the operation result of the matrix multiplication operation between the one-axis tensor 601 and the two-axis tensor 602. In the example shown in FIG. 6, after the calculation unit 104 performs the element multiplication and accumulation process for the element g₁ (which is the current first element at present) and the element 6021 (which is the currently loaded element at present) corresponding to the element g₁, the accumulated value o₁ is h₁₁·g₁+h₄₁·g₄+h₅₁·g₅+h₇₁·g₇, the accumulated value o₂ is h₁₂·g₁+h₄₂·g₄+h₅₂·g₅+h₇₂·g₇, . . . , and the accumulated value o₉ is h₁₉·g₁+h₄₉·g₄+h₅₉·g₅+h₇₉·g₇.

In some embodiments of the present invention, when the control unit 103 transmits a last current first element and the currently loaded element corresponding to the last current first element among the to-be-loaded elements, a signal is transmitted to the calculation unit 104. In this way, the calculation unit 104 processes the last current first element and the currently loaded element corresponding to the last current first element among the to-be-loaded elements, and then outputs the accumulated value of each of the accumulation units 702-1 to 702-N (which are the accumulation units 6061-6069 in the embodiment of FIG. 6) as the operation result of the matrix multiplication operation between the one-axis tensor and the two-axis tensor.

Referring to FIG. 1 and FIG. 6 again, in some embodiments of the present invention, the selection condition of the selection unit 101 is not between the first threshold and the second threshold, where the first threshold is less than the second threshold. Referring to FIG. 6, if the element g₁=100, the element g_{2=0.02}, the element g_{3=0.01}, the element g₄=200, the element g₅=600, the element g₆=0.015, the element g₇=500, and the element g₈=0.025, the foregoing first threshold is 0.005, and the foregoing second threshold is 0.1. The selection unit 101 selects the element g₁=100, the element g₄=200, the element g₅=600, and the element g₇=500 that are not between the first threshold and the second threshold (that is, not between an open interval of (0.005, 0.1)).

In some embodiments of the present invention, values close to 0 are selected for both the first threshold and the second threshold. In this case, a value of the element that is not selected by the selection unit 101 is also close to 0. Therefore, a product of the element that is not selected by the selection unit 101 and a corresponding value in the two-axis tensor also needs to be close to 0 and may be ignored in the operation of the matrix multiplication. Therefore, the selection unit 101 does not select an element whose value is between the first threshold and the second threshold.

In some embodiments of the present invention, the values of the first threshold and the second threshold are obtained through statistics of a set of calibration datasets in an offline stage.

FIG. 8 is a block diagram of a calculation device according to some embodiments of the present invention. Referring to FIG. 8, compared with the calculation device 100 shown in FIG. 1, a calculation device 800 shown in FIG. 8 further includes a statistics unit 801. The statistics unit 801 is configured to first generate a first threshold and a second threshold based on elements of a current one-axis tensor (for example, the elements g₁-g₈ of the one-axis tensor 601 in FIG. 6).

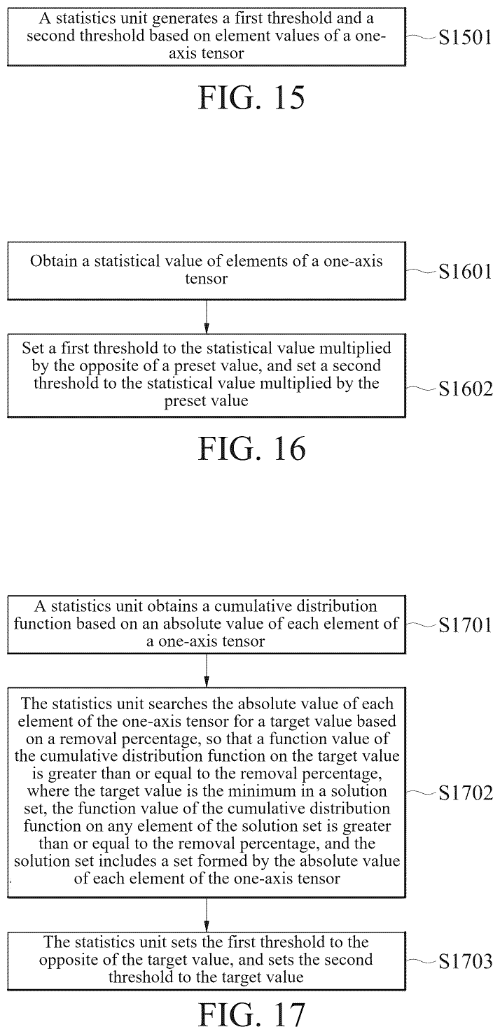

FIG. 15 is a flowchart of a calculation method according to some embodiments of the present invention. Referring to FIG. 8, FIG. 11, and FIG. 15 together, in an embodiment shown in FIG. 15, the calculation method includes step S1501 before the foregoing step S1101. In step S1501, the statistics unit 801 generates a first threshold and a second threshold based on elements of a one-axis tensor (for example, the elements g₁-98 of the one-axis tensor 601 in FIG. 6).

FIG. 16 is a flowchart of a calculation method according to some embodiments of the present invention. Referring to FIG. 15 and FIG. 16 together, in the embodiment shown in FIG. 16, step S1501 includes steps S1601-S1602. In step S1601, the statistics unit 801 obtains a statistical value of elements of a one-axis tensor (for example, the elements g₁-g₈ of the one-axis tensor 601 in FIG. 6). In step S1602, the statistics unit 801 sets the first threshold to the statistical value multiplied by the opposite of a preset value, and sets the second threshold to the statistical value multiplied by the preset value, where the preset value is a positive number.

For example, if the preset value is 0.5, and the statistical value obtained by the statistics unit 801 is S, the statistics unit 801 sets the first threshold to the statistical value multiplied by −0.5 and the second threshold to the statistical value multiplied by 0.5.

In some embodiments of the present invention, the foregoing statistical value is an average of the elements of the one-axis tensor.

In some embodiments of the present invention, the foregoing statistical value is a median of the elements of the one-axis tensor.

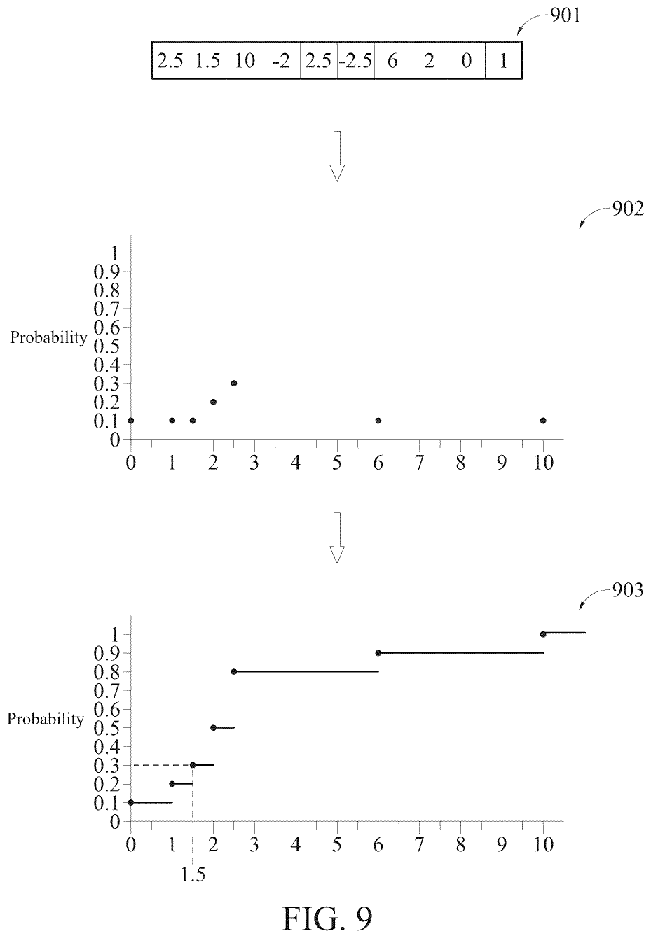

FIG. 9 is a schematic flowchart of a calculation method according to some embodiments of the present invention. FIG. 17 is a flowchart of a calculation method according to some embodiments of the present invention. Referring to FIG. 9 and FIG. 17 together, in an embodiment shown in FIG. 17, step S1501 includes steps S1701-S1703. In step S1701, the statistics unit 801 obtains a cumulative distribution function based on an absolute value of each of the elements of the one-axis tensor. An embodiment shown in FIG. 9 is used as an example for description. A one-axis tensor 901 has elements 2.5, 1.5, 10, −2, 2.5, −2.5, 6, 2, 0, and 1. It may be learned based on the foregoing elements of the one-axis tensor 901 that a probability 3 that the absolute value of the element of the one-axis tensor 901 is 2.5 is 3/10 (because a quantity 10 of elements of the one-axis tensor 901 is 10, and the absolute values of three elements are 2.5), a probability that the absolute value of the element of the one-axis tensor 901 is 1.5 is 1/10, a probability that the absolute value of the element of the one-axis tensor 901 is 10 is 1/10, a probability that the absolute value of the element of the one-axis tensor 901 is 2 is 2/10, a probability that the absolute value of the element of the one-axis tensor 901 is 6 is 1/10, a probability that the absolute value of the element of the one-axis tensor 901 is 0 is 1/10, and a probability that the absolute value of the element of the one-axis tensor 901 is 1 is 1/10. Based on the foregoing probabilities, a probability density function 902 may be obtained. A cumulative distribution function 903 may be obtained from the probability density function 902. It is to be noted that the probability density function 902 and the cumulative distribution function 903 both have function values only on the absolute value of the element of the one-axis tensor. Therefore, during implemented in a computer, the probability density function 902 and the cumulative distribution function 903 may be stored in a data structure such as an array or a dictionary, and the cumulative distribution function 903 is obtained by accumulating the function value of the probability density function 902.

In step S1702, the statistics unit 801 searches the absolute value of each of the elements of the one-axis tensor for a target value based on a removal percentage, so that a function value of the cumulative distribution function on the target value is greater than or equal to the removal percentage, where the target value is the minimum in a solution set, the function value of the cumulative distribution function on any element of the solution set is greater than or equal to the removal percentage, and the solution set includes a set formed by the absolute value of each of the elements of the one-axis tensor. In other words, the statistics unit 801 finds the minimum as the target value in the solution set that “enables the function value of the cumulative distribution function on the target value to be greater than or equal to the removal percentage”. In an actual operation, the cumulative distribution function value of the cumulative distribution function generated in the foregoing steps only changes on the absolute value of the element of the one-axis tensor, and the cumulative distribution function is a non-decreasing function. Therefore, during searching of the foregoing target value, a first numerical value found through searching of the absolute values of all of the elements of the one-axis tensor in ascending order that enables the function value of the cumulative distribution function on the target value to be greater than or equal to the removal percentage is the target value.

The embodiment shown in FIG. 9 is used as an example. The foregoing removal percentage is 0.3 (that is, 30 percent), and the statistics unit 801 may find 1.5 that “enables the function value of the cumulative distribution function on the target value to be greater than or equal to the removal percentage”, and 1.5 is a smallest possible solution. Therefore, the target value is 1.5.

In step S1703, the statistics unit 801 sets the first threshold to the opposite of the target value, and sets the second threshold to the target value. The embodiment shown in FIG. 9 is used as an example. The statistics unit 801 sets the first threshold to −1.5 and the second threshold to 1.5.

In the embodiment shown in FIG. 17, a specified percentage may be removed from the current one-axis tensor. If the removal percentage is set to 0.3, a memory bandwidth required to read a two-axis tensor can be reduced by nearly 30%, so as to achieve the effect of limiting the memory bandwidth.

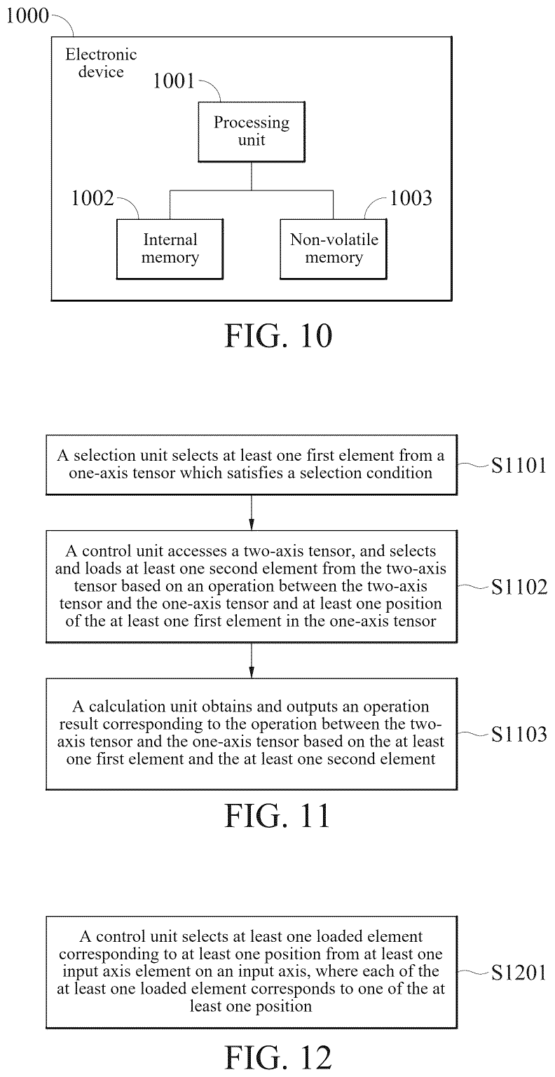

FIG. 10 is a schematic system block diagram of an electronic device according to some embodiments of the present invention. As shown in FIG. 10, at a hardware level, an electronic device 1000 includes a processing unit 1001, an internal memory 1002, and a non-volatile memory 1003. The internal memory 1002 is for example a random-access memory (RAM). Certainly, the electronic device 1000 may further include hardware required for another function.

The internal memory 1002 and the non-volatile memory 1003 are configured to store programs. The programs may include program code, and the program code includes computer operation instructions. The internal memory 1002 and the non-volatile memory 1003 provide instructions and data to the processing unit 1001. The processing unit 1001 reads the corresponding computer program from the non-volatile memory 1003 into the internal memory 1002 and then runs the computer program. All or part of the calculation device 100 or the selection unit 101, the control unit 103, the calculation unit 104, and the statistics unit 801 in the calculation device 800 are formed at a logic level. The internal memory 1002 may be configured to implement the foregoing memory unit 102. The calculation device 100 or the selection unit 101, the control unit 103, the calculation unit 104, and the statistics unit 801 in the calculation device 800 may also be implemented by using a hardware circuit.

The processing unit 1001 may be an integrated circuit chip having a signal processing capability. During implementation, the methods and steps disclosed in the foregoing embodiments may be completed through an integrated logic circuit of hardware in the processing unit 1001 or an instruction in a form of software. The processor 1001 may be a general-purpose processor, including a central processing unit (CPU), a tensor processing unit, a digital signal processor (DSP), an application-specific integrated circuit (ASIC), a field-programmable gate array (FPGA), or another programmable logic device, so as to implement or perform the methods and the steps disclosed in the foregoing embodiments.

An example of the computer storage medium includes, but is not limited to, a phase-change memory (PRAM), a static RAM (SRAM), a dynamic RAM (DRAM), another type of RAM, a read-only memory (ROM), an electrically erasable programmable ROM (EEPROM), a flash memory or other internal memory technologies, a compact disc ROM (CD-ROM), a digital versatile disc (DVD) or another optical storage, a magnetic tape cassette, a magnetic tape disk storage or another magnetic storage device, or any other non-transmission medium that may be configured to store information accessible by a calculation device. According to the definition in this specification, the computer-readable medium does not include transitory media, for example, modulated data signals and carrier waves.

Based on the above, according to the calculation device and the calculation method provided in some embodiments of the present invention, since an amount of data that needs to be loaded from the external memory is reduced, a quantity of inputs and outputs of the memory may be reduced, and the memory bandwidth required to read the two-axis tensor may also be reduced.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A calculation device, comprising:
a selection unit, configured to select at least one first element from a one-axis tensor which satisfies a selection condition;
a control unit, configured to perform a step of: (a) selecting and loading at least one second element from a two-axis tensor based on an operation between the two-axis tensor and the one-axis tensor and at least one position of the at least one first element in the one-axis tensor; and
a calculation unit, configured to perform a step of: (b) obtaining and outputting an operation result corresponding to the operation between the two-axis tensor and the one-axis tensor based on the at least one first element and the at least one second element.

2. The calculation device according to claim 1, wherein the operation is a matrix multiplication operation, the two-axis tensor comprises an input axis and an output axis, and the step (a) comprises: selecting at least one to-be-loaded element corresponding to the at least one position from at least one input axis element on the input axis, wherein each of the at least one to-be-loaded element corresponds to one of the at least one position, and the at least one second element comprises a plurality of elements of each of the at least one to-be-loaded element.

3. The calculation device according to claim 2, wherein the step (a) comprises: successively loading, according to a sequence of the at least one position, the at least one to-be-loaded element corresponding to the at least one position based on the sequence from an external memory through direct memory access (DMA).

4. The calculation device according to claim 2, wherein the calculation unit comprises a multiplication unit and a plurality of accumulation units, a quantity of accumulation units is a dimension of the two-axis tensor on the output axis, and the step (b) comprises:
(b1) receiving a current first element in the at least one first element and a currently loaded element in the at least one to-be-loaded element that corresponds to the current first element; and
(b2) performing an element multiplication and accumulation process, wherein the element multiplication and accumulation process comprises: (b21) multiplying, by the multiplication unit, a current element in the currently loaded element by the current first element to obtain a multiplication result; and (b22) inputting the multiplication result into a current accumulation unit corresponding to an element position of the current element in the accumulation units to update an accumulated value of the current accumulation unit; and exiting the element multiplication and accumulation process in response to a plurality of elements of the currently loaded element being processed, and selecting, in response to the elements of the currently loaded element having not been fully processed, a next element in a next position of the current element as the current element and performing step (b21).

5. The calculation device according to claim 1, wherein the selection condition is not between a first threshold and a second threshold, wherein the first threshold is less than the second threshold.

6. The calculation device according to claim 5, comprising a statistics unit, wherein the statistics unit is configured to perform a step of: (c) generating the first threshold and the second threshold based on a plurality of elements of the one-axis tensor.

7. The calculation device according to claim 6, wherein the step (c) comprises:
(c1) obtaining a statistical value of the elements of the one-axis tensor; and
(c2) setting the first threshold to the statistical value multiplied by the opposite of a preset value, and setting the second threshold to the statistical value multiplied by the preset value, wherein the preset value is a positive number.

8. The calculation device according to claim 7, wherein the statistical value is an average of the elements of the one-axis tensor.

9. The calculation device according to claim 7, wherein the statistical value is a median of the elements of the one-axis tensor.

10. The calculation device according to claim 6, wherein the step (c) comprises:
(c1) obtaining a cumulative distribution function based on an absolute value of each of the elements of the one-axis tensor;
(c2) searching the absolute value of each of the elements of the one-axis tensor for a target value based on a removal percentage, so that a function value of the cumulative distribution function on the target value is greater than or equal to the removal percentage, wherein the target value is the minimum in a solution set, a function value of the cumulative distribution function on any element of the solution set is greater than or equal to the removal percentage, and the solution set includes a set formed by the absolute value of each of the elements of the one-axis tensor; and
(c3) setting the first threshold to the opposite of the target value, and setting the second threshold to the target value.

11. A calculation method, comprising:
(a) selecting, by a selection unit, at least one first element from a one-axis tensor which satisfies a selection condition;
(b) selecting and loading, by a control unit, at least one second element from a two-axis tensor based on an operation between the two-axis tensor and the one-axis tensor and at least one position of the at least one first element in the one-axis tensor; and
(c) obtaining and outputting, by a calculation unit, an operation result corresponding to the operation between the two-axis tensor and the one-axis tensor based on the at least one first element and the at least one second element.

12. The calculation method according to claim 11, wherein the operation is a matrix multiplication operation, the two-axis tensor comprises an input axis and an output axis, and the step (b) comprises: selecting, by the control unit, at least one to-be-loaded element corresponding to the at least one position from at least one input axis element on the input axis, wherein each of the at least one to-be-loaded element corresponds to one of the at least one position, and the at least one second element comprises a plurality of elements of each of the at least one to-be-loaded element.

13. The calculation method according to claim 12, wherein the step (b) comprises: successively loading, by the control unit, according to a sequence of the at least one position, the at least one to-be-loaded element corresponding to the at least one position based on the sequence from an external memory through DMA.

14. The calculation method according to claim 12, wherein the calculation unit comprises a multiplication unit and a plurality of accumulation units, a quantity of accumulation units is a dimension of the two-axis tensor on the output axis, and the step (c) comprises the following steps performed by the calculation unit:
(c1) receiving a current first element in the at least one first element and a currently loaded element in the at least one to-be-loaded element that corresponds to the current first element; and
(c2) performing an element multiplication and accumulation process, wherein the element multiplication and accumulation process comprises: (c21) multiplying, by the multiplication unit, a current element in the currently loaded element by the current first element to obtain a multiplication result; and (c22) inputting the multiplication result into a current accumulation unit corresponding to an element position of the current element in the accumulation units to update an accumulated value of the current accumulation unit; and exiting the element multiplication and accumulation process in response to a plurality of elements of the currently loaded element being processed, and selecting, in response to the elements of the currently loaded element having not been fully processed, a next element in a next position of the current element as the current element and performing step (c21).

15. The calculation method according to claim 11, wherein the selection condition is not between a first threshold and a second threshold, wherein the first threshold is less than the second threshold.

16. The calculation method according to claim 15, wherein before the step (a), the calculation method comprises a step of: (d) generating, by a statistics unit, the first threshold and the second threshold based on a plurality of elements of the one-axis tensor.

17. The calculation method according to claim 16, wherein the step (d) comprises:
(d1) obtaining, by the statistics unit, a statistical value of the elements of the one-axis tensor; and
(d2) setting, by the statistics unit, the first threshold to the statistical value multiplied by the opposite of a preset value, and setting the second threshold to the statistical value multiplied by the preset value, wherein the preset value is a positive number.

18. The calculation method according to claim 17, wherein the statistical value is an average of the elements of the one-axis tensor.

19. The calculation method according to claim 17, wherein the statistical value is a median of the elements of the one-axis tensor.

20. The calculation method according to claim 16, wherein the step (d) comprises:
(d1) obtaining, by the statistics unit, a cumulative distribution function based on an absolute value of each of the elements of the one-axis tensor;
(d2) searching, by the statistics unit, the absolute value of each of the elements of the one-axis tensor for a target value based on a removal percentage, so that a function value of the cumulative distribution function on the target value is greater than or equal to the removal percentage, wherein the target value is the minimum in a solution set, a function value of the cumulative distribution function on any element of the solution set is greater than or equal to the removal percentage, and the solution set includes a set formed by the absolute value of each of the elements of the one-axis tensor; and
(d3) setting, by the statistics unit, the first threshold to the opposite of the target value, and setting the second threshold to the target value.
